(19) United States
(12) Patent Application Publication
(10) Pub. No.: US 2003/0002240 A1
(43) Pub. Date: Jan. 2, 2003

(54) Electrical device having components arranged in a casing and outwardly electromagnetically shielded

(75) Inventors: Peter Lindmueller, Essingen (DE); Michael Ludwig, Karlsruhe (DE); Tim Schwegler, Sindelfingen (DE)

Correspondence Address: SUGHRUE MION, PLLC, 2100 Pennsylvania Avenue, NW, Washington, DC, 20037-3213, US

(73) Assignee: SIEMENS AG

(21) Appl. No.: 10/109,841

(22) Filed: Apr. 1, 2002

Related U.S. Application Data
(63) Continuation of application No. PCT/DE00/03427, filed on Sep. 28, 2000.

(30) Foreign Application Priority Data
Sep. 30, 1999 (DE) 19947130.4

(51) Int. Cl. H02B 1/00

(52) U.S. Cl. 361/600

(57) ABSTRACT

An electrical device having components (1, 2, 3) that are arranged in a casing (4; 10) and are electromagnetically shielded in an outward manner. In the casing, spaces provided between the casing and the components as well as between the components themselves are completely filled with plastic parts (5, 6; 13) provided with ferrite particles (9). These plastic parts are preferably provided in the form of shaped plastic parts in which the components are held with form fit.

This is a Continuation of International Application PCT/DE00/03427, with an international filing date of Sep. 28, 2000 which was published under PCT Article 21(2) in German, and the disclosure of which is incorporated into this application by reference.

### FIELD OF AND BACKGROUND OF THE INVENTION

The invention relates to an electrical device having components that are arranged in a casing and are electromagnetically shielded vis a vis the exterior.

In such an electrical device, known from U.S. Pat. No. 5,539,148, the inner wall of the plastic casing from the exterior toward the interior is provided with a conductive layer and a layer with ferrite particles embedded in a resin. As a result, electromagnetic radiation in the interior of the casing is reflected on the conductive layer and dampened in the ferrite-containing layer.

U.S. Pat. No. 4,699,743 teaches shrink-fitting a ferrite-filled plastic material as a shield onto electrical components.

The abstract of JP 59-227920 Al discloses a ferrite-filled polyurethane foam for absorbing electromagnetic waves. It is generally known to use appropriate pyramid-shaped or truncated pyramid-shaped foam parts are used as an interior lining of the walls of EMC cabinets in which, inter alia, the electromagnetic compatibility of electrical devices is tested.

U.S. Pat. No. 5,682,289 discloses a casing concept in which the components of electrical devices are held in place in a form-fitting manner in corresponding recesses of molded plastic parts, preferably made of foam materials, such as polyurethane or expanded polypropylene (EPP). This casing concept is also known under the name of E-PAC®

### OBJECTS OF THE INVENTION

One primary object of the invention is to achieve effective electromagnetic shielding of the components of electrical devices in an especially simple manner.

### SUMMARY OF THE INVENTION

According to one formulation of the invention, this and other objects are attained by filling in the spaces in the casing of an electrical device of the above-described type that are present between the casing and the components as well as spaces between the components themselves with plastic parts provided with ferrite particles. According to another formulation, the invention provides an electrical device having electromagnetically shielded components and at least one plastic part provided with ferrite particles. The plastic part forms a casing and fills the spaces between the components.

Contrary to the prior-art shielding measures in electrical devices, damping of the electromagnetic radiation is effected at least largely in the interior of the device, rather than on a boundary layer that is formed, for instance, by a layer or a casing wall between the interior of the device and the exterior environment. This renders the shielding arrangement according to the invention particularly effective. Furthermore, this shielding is effective not only with respect to the exterior but also within the device between the components that are separated from one another by the plastic parts provided with ferrite particles. Since the ferrite particles are non-conducting, the individual components of the electrical device can directly contact the plastic parts without thereby having an adverse effect on the dielectric strength of the electrical device or causing short circuits.

In accordance with the casing concept described in the aforementioned U.S. Pat. No. 5,682,289, the plastic parts are preferably formed by the space-filling portions of at least one shaped plastic part in which the components are held in a form-fitting manner. Alternatively, the plastic parts filling in the spaces are packing bodies, which are, for instance, spherical.

in the E-PAC® concept of the prior art, the plastic parts and/or the shaped plastic parts are preferably made of a foam material.

The plastic parts can be coated on the outside with ferrite particles in defined areas. Preferably, the plastic parts contain the ferrite particles, to provide spatial and thus particularly effective damping. Even in the latter case, the plastic parts may be provided with an outer coating of ferrite particles in addition.

Loading of the plastic parts with ferrite particles is carried out prior to molding, for instance by blending with the polymer, or prior to foaming the polymer if the plastic parts are formed by fusing plastic beads, as is the case, for instance, in expanded polypropylene, the plastic beads are preferably first coated with the ferrite particles, e.g., through tumbling. For effective electromagnetic damping in the frequency range of interest, i.e. between 80 and 300 MHz, loading the plastic parts with ferrite particles at a ratio of 2 to 10% by volume has proven to be advantageous.

The casing of the electrical device is preferably electrically conductive on the outside, essentially to prevent electromagnetic radiation from penetrating into the interior of the casing or to prevent electromagnetic radiation from being emitted from the casing. At some frequencies, however, electromagnetic fields, for which the casing forms a resonant cavity, may penetrate via casing openings or cable ducts. The plastic parts provided with ferrite particles substantially dampen, in particular, electromagnetic fields magnified by resonance. Electromagnetic fields with frequencies outside of resonances are reflected by the conductive casing. In the simplest case, the electrically conductive casing is a metal casing in the interior of which the components of the electrical device are arranged together with the plastic parts. With the use of shaped plastic parts, however, the outlying shaped plastic parts can themselves form the casing and, if necessary, can be provided on the outside with an electrically conductive coating.

### BRIEF DESCRIPTION OF THE DRAWINGS

The invention will now be described in greater detail with reference to the drawing in which:

FIG. 1 shows a first exemplary embodiment and

FIG. 2 a second exemplary embodiment of the electrical device with shaped plastic parts according to the invention; and

FIG. 3 shows an additional embodiment of the device with plastic parts serving as filler bodies.

### DETAILED DESCRIPTION OF THE PREFERRED EMBODIMENTS

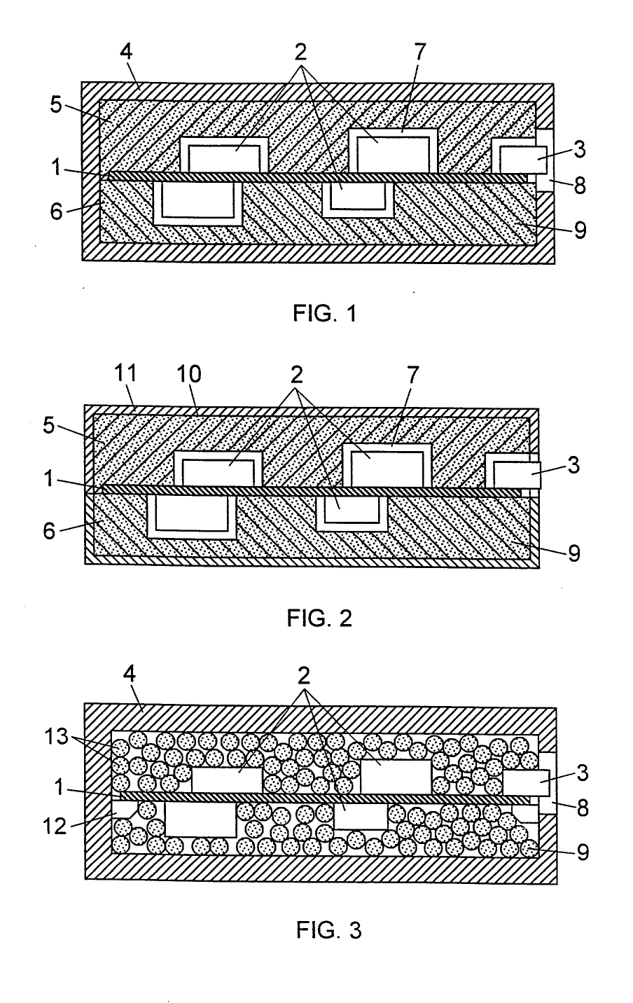

FIG. 1 schematically depicts an electrical device, the components of which include a printed circuit board 1 with elements 2 arranged thereon as well as a connector 3. The components 1, 2 and 3 of the electrical device are arranged within a metal casing 4 together with two shaped plastic parts 5 and 6. Components 1, 2 and 3 are held in corresponding recesses 7 of the shaped plastic parts 5 and 6 in a form-fitting manner. The connector 3 is accessible from the outside through an opening 8 in the metal casing 4, so that electromagnetic radiation can penetrate through this opening 8 into the interior of the casing. In order to absorb this radiation penetrating into the interior of the casing as well as to absorb the electromagnetic radiation emitted by the electrical device itself, the shaped plastic parts 5 and 6 are filled with ferrite particles 9 in the form of a ferrite powder at a ratio from 2 to 10% by volume.

The embodiment of the electrical device shown in FIG. 2 differs from that of FIG. 1 in that, instead of utilizing a metal casing 4, the shaped plastic parts 5 and 6 themselves form a casing 10 toward the exterior. To make the exterior of the casing 10 electrically conductive, the plastic parts 5 and 6 are provided with an electrically conductive coating 11 on the outside.

In the exemplary embodiment shown in FIG. 3, the printed circuit board 1 is held in metal casing 4 by means of fastening elements 12. For absorption of electromagnetic radiation, the spaces between casing 4 and the components 1, 2 and 3, as well as the spaces between the components 1, 2 and 3 themselves, are filled with uniformly shaped plastic parts 13 that are loaded with ferrite particles 9.

The above description of the preferred embodiments has been given by way of example. From the disclosure given, those skilled in the art will not only understand the present invention and its attendant advantages, but will also find apparent various changes and modifications to the structures and methods disclosed. It is sought, therefore, to cover all such changes and modifications as fall within the spirit and scope of the invention, as defined by the appended claims, and equivalents thereof

What is claimed is:

1. Electrical device, comprising:
a casing;
electromagnetically shielded components arranged inside the casing; and plastic parts provided with ferrite particles essentially filling spaces provided in the casing between the casing and the components, as well as spaces between the components.

2. Electrical device as claimed in claim 1, wherein the plastic parts comprise at least one shaped plastic part in which at least a portion of the components are held in a form-fitting manner.

3. Electrical device as claimed in claim 2, wherein the shaped plastic part fills in spaces between the held portion of the components.

4. Electrical device as claimed in claim 1, wherein the plastic parts are made of a foam material.

5. Electrical device as claimed in claim 1, wherein the plastic parts are coated with ferrite particles in predefined areas.

6. Electrical device as claimed in claim 5, wherein the plastic parts consist of fused plastic beads that have previously been coated with ferrite particles.

7. Electrical device as claimed in claim 1, wherein the ferrite particles are contained in the plastic parts.

8. Electrical device as claimed in claim 7, wherein the plastic parts consist of fused plastic beads that have previously been coated with ferrite particles.

9. Electrical device as claimed in claim 7, wherein the plastic parts are loaded with ferrite particles at a ratio of 2 to 10% by volume.

10. Electrical device as claimed in claim 8, wherein the plastic parts are loaded with ferrite particles at a ratio of 2 to 10% by volume.

11. Electrical device as claimed in claim 1, wherein the casing is externally electrically conductive.

12. Electrical device, comprising:
electromagnetically shielded components; and
at least one plastic part provided with ferrite particles, said plastic part forming a casing and essentially filling spaces between the components.
